(19) United States
(12) Patent Application Publication
(10) Pub. No.: US 2016/0137882 A1
(43) Pub. Date: May 19, 2016

(54) CROSSLINKABLE ADHESIVE TAPES

(71) Applicant: Saint-Gobain Performance Plastics Corporation, Aurora, OH (US)

(72) Inventors: Xiaonan ZHU, Shanghai (CN); Yue DONG, Shanghai (CN)

(21) Appl. No.: 14/928,562

(22) Filed: Oct. 30, 2015

(30) Foreign Application Priority Data
Nov. 14, 2014 (CN) 201410602703.1

(51) Int. Cl. C09J 7/02; C09J 133/00

(52) U.S. Cl. CPC C09J 7/0203; C09J 133/00; C09J 2433/00

(57) ABSTRACT

Embodiments of the present disclosure relate to adhesive tapes containing an adhesive resin and a crosslinkable component. The novel tapes can exhibit synergistic improvements in parameters such as modulus, overlap shear strength, shelf life, and others.

### CROSS-REFERENCE TO RELATED APPLICATION(S)

This application claims priority to Chinese Application No. 201410602703.1, filed Nov. 14, 2014, entitled “CROSSLINKABLE ADHESIVE TAPES,” by Zhu et al. Each patent application cited herein is hereby incorporated by reference in its entirety.

### FIELD OF THE DISCLOSURE

The present disclosure relates to adhesive tapes, and more particularly to structural bonding tapes.

### RELATED ART

Adhesive tapes are used in a wide range of applications, and can be particularly useful when strong overlap shear strength over an extended period of time, in the order of years, is desired. For example, structural bonding tapes are used for adhering automotive parts such as rear view mirrors and rain sensors to windshields.

The current solutions in the marketplace all have drawbacks. For example, the structural bonding tapes produced by 3M and identified as 3M™ Automotive Structural Bonding Tape 9214 and 9270 are two examples. These tapes are formulated for bonding of rear view mirror buttons to automotive windshield glass, and are applied as a pressure-sensitive tape, and then heat-cured to develop structural strength. These tapes offer good overlap shear strength, but suffer in low shelf life and exhibit high modulus at low temperatures, limiting the ability to use the bonding tape in cold weather.

Embodiments of the present disclosure overcome these drawbacks and can further provide additional advantages including a synergistic improvement between overlap shear strength, shelf life, and modulus as will be described in detail below.

### BRIEF DESCRIPTION OF THE DRAWINGS

Embodiments are illustrated by way of example and are not limited in the accompanying figures.

FIG. 1 includes an illustration of a single layer adhesive tape according to one embodiment.

FIG. 2 includes an illustration of a single layer adhesive tape with a release liner according to one embodiment.

FIG. 3 includes an illustration of a single adhesive tape with two release liners according to one embodiment.

FIG. 4 includes an illustration of a multi-layer adhesive tape according to an embodiment.

FIG. 5 includes an illustration of a multi-layer adhesive tape according to an embodiment.

FIG. 6 includes a graph of the modulus across the temperature range tested in Example 1.

FIG. 7 includes a graph representing the results of the rheology shelf life tested in Example 2b.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the adhesive arts.

The present disclosure is generally directed to curable adhesive tapes, such as tapes containing an adhesive resin layer including a crosslinkable component. Embodiments of the disclosure can exhibit improved synergistic benefits in parameters such as shelf life, application temperature range and conformability, and others. The concepts are better understood in view of the embodiments described below that illustrate and do not limit the scope of the present invention.

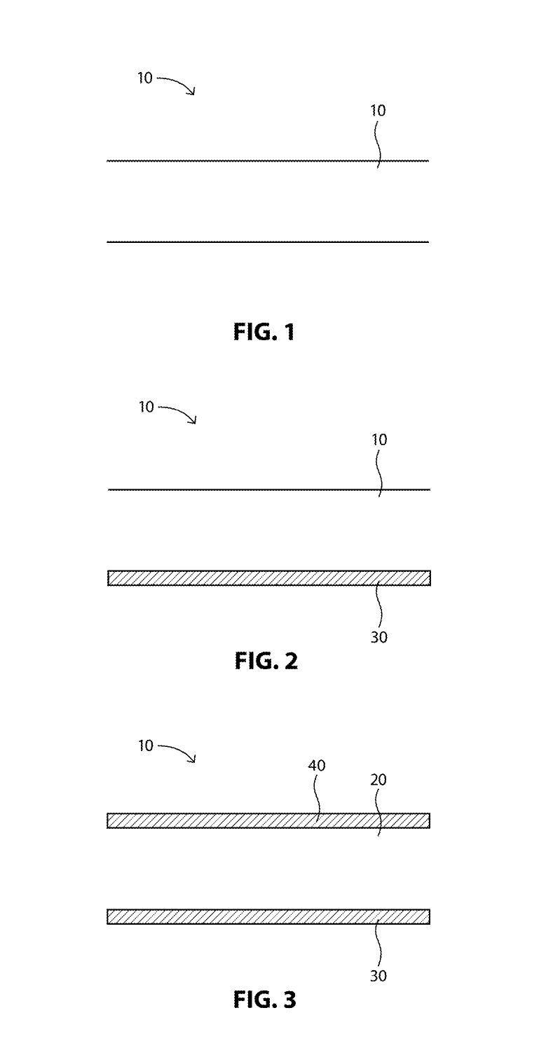

Referring to FIG. 1, in certain embodiments, the curable adhesive tape 10 can contain an adhesive layer 20 comprising an adhesive resin and a crosslinkable component.

In certain embodiments, as more particularly illustrated in FIG. 2, can be a transfer tape 10 which includes the adhesive layer 20 and a release layer 30, such as a removable release liner. In further embodiments, as illustrated in FIG. 3, the adhesive tape 10 can further include a second release layer 40, such as a removable release liner. It is to be understood that any adhesive layer that is adapted to adhere to a component can include a release layer as described herein adjacent to the adhesive layer to thereby protect the adhesive layer until ready for use, at which point the release layer(s) can be removed exposing the adhesive layer.

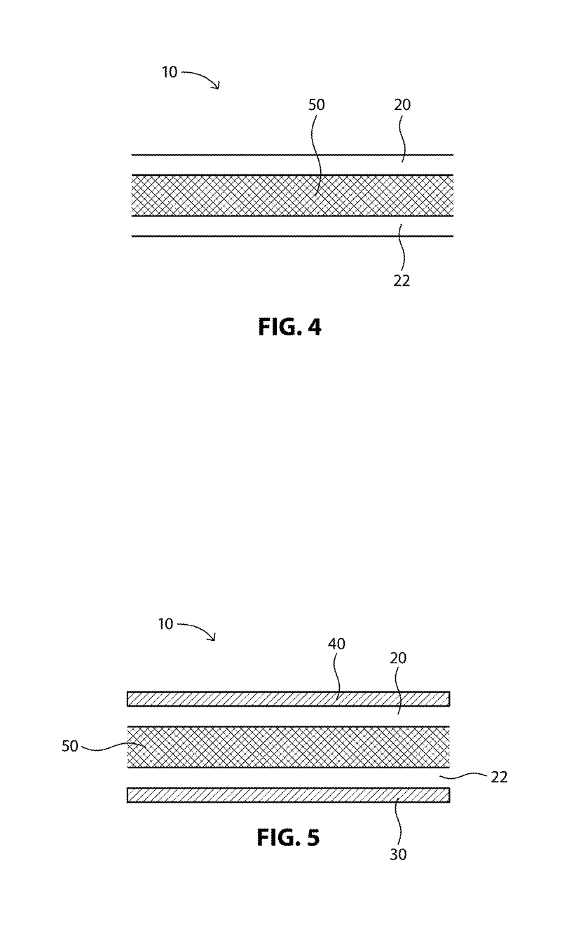

In certain further embodiments, as particularly illustrated in FIGS. 4-5, the adhesive tape 10 can include a core layer 50, a first adhesive layer 20, and a second adhesive layer 22. The core layer 50 can be disposed between the adhesive layers 20,22. As illustrated in FIG. 5, the adhesive tape 10 including a core layer 50 can further include first and second release liners 30, 40 disposed adjacent the adhesive layers 20,22 and opposite the core layer 50.

The core layer 50 can include a single layer or, in certain embodiments, a multi-layer construct. In particular embodiments, the core layer 50 can include a single layer in direct contact on both major surfaces with an adhesive layer 20,22. Accordingly, the adhesive layers 20,22 can form outer layers of the adhesive tape (not including any release layers, if present).

In embodiments, where two adhesive layers are present, such as described in FIG. 4, which includes a first adhesive layer 20 and a second adhesive layer 22, the adhesive composition forming the first adhesive layer and the second adhesive layer can be substantially the same. In other embodiments, the first adhesive layer 20 and the second adhesive layer 22 can be different, such as, having different thickness, or constituents, or different embodiments of the adhesive layer described herein. Accordingly, it is to be understood that the foregoing description of an adhesive layer can include characteristics of the first adhesive layer 20 and/or the second adhesive layer 22.

In certain embodiments, the first adhesive layer 20 and/or the second adhesive layer 22 can have an average thickness of no greater than 2 mm, no greater than 1.5 mm, no greater than 1 mm, less than 0.6 mm, no greater than 0.55 mm, no greater than 0.50 mm, or even no greater than 0.4 mm. In certain embodiments, the first adhesive layer 20 and/or the second adhesive layer 22 can have an average thickness of at least 0.001 mm, at least 0.01 mm, or even at least 0.05 mm. Moreover, in certain embodiments, the first adhesive layer 20 and/or the second adhesive layer 22 can have a thickness in a range of any of the minimums and maximums provided above, such as in a range of from 0.01 mm to 2 mm.

In certain embodiments, the adhesive tape 10 can have an average thickness of no greater than 25 mm, no greater than 22 mm, no greater than 20 mm, no greater than 18 mm, no greater than 16 mm, no greater than 15 mm, no greater than 14 mm, no greater than 13 mm, no greater than 12 mm, or even no greater than 11 mm. In certain embodiments, the adhesive tape can have an average thickness of at least 0.01 mm, at least 0.05 mm, or even at least 0.1 mm. Moreover, in certain embodiments, the adhesive tape 10 can have a thickness in a range of any of the minimums and maximums provided above. It is to be understood that the thickness of the adhesive tape 10 is the thickness of the first adhesive layer 20 when only a single adhesive layer is present in the adhesive tape, or is the thickness between and including the first adhesive layer 20 and the second adhesive layer 22 such as when a core layer is present. The release layers, if present, are not included in the determination of the average thickness of the adhesive tape as described herein.

In certain embodiments, when present, the core layer 50 can have an average thickness of at least 0.001 mm, at least 0.01 mm, at least 0.05 mm, or even at least 0.1 mm. In certain embodiments, when present, the core layer 50 can have an average thickness of no greater than 22 mm, no greater than 20 mm, no greater than 18 mm, no greater than 16 mm, no greater than 15 mm, no greater than 14 mm, no greater than 13 mm, no greater than 12 mm, no greater than 11 mm, no greater than 10 mm, no greater than 9 mm, no greater than 8 mm, or even no greater than 7 mm. Moreover, the core layer 50 can have a thickness in a range of any of the minimums and maximums provided above, such as in a range of from 0.001 mm to 22 mm.

In particular embodiments, the core layer 50 can include a sheet material. For example, the sheet material can be a film layer, a foamed layer, a fabric layer such as a woven or nonwoven fabric layer, or combinations thereof.

In certain embodiments, the core layer 50 can include a film layer. In further embodiments, the core layer 50 can include a foam layer.

In particular embodiments, the core layer 50 can include a PET layer, a TPU layer, a TPE layer, a PU layer, a PA layer, or combinations thereof.

In certain embodiments, the core layer 50 can include a thermoplastic film.

In certain embodiments, the core layer 50 can include a fabric layer. For example, the core layer 50 can include a woven fabric layer.

In other embodiments, the core layer 50 can include a non-woven fabric layer.

In further embodiments, the core layer 50 can have a comparable mechanical strength to the cured adhesive layer. For example, the core layer 50 can have a mechanical strength within about 20%, within about 15%, or even within about 10% of the cured adhesive layer.

In certain embodiments, the modulus of the core layer 50 can be at least 1×10⁸ as measured at room temperature. In further embodiments, the modulus of the core layer 50 can be at least 1×10⁷ as measured at 150 degrees Celsius.

In further embodiments, the core layer 50 can have good heat and water resistance.

In certain embodiments, the core layer 50 can include a multi-layer construct. The multilayer construct can include any variation of the layers described herein. For example, in a particular embodiments, the core layer 50 can include a multilayer construct including at least two layers, at least three layers, at least 4 four layers, or even at least 5 layers. Specific examples of a multilayer core layer can include, but are not limited to, foam/film/foam; film/foam/film; fabric/foam; fabric/film; film/fabric/film; fabric/film/fabric; fabric/foam/fabric; film/foam; or combinations thereof.

In particular embodiments, particularly useful core layers 50 can be described by their shear strength, particularly when the adhesive tape is being used for long term bonding applications. Accordingly, in certain embodiments, the core layer can have a shear strength of at least 2 MPa, at least 3 MPa, at least 4 MPa, at least 5 MPa, at least 6 MPa, or even at least 7 MPa.

In other embodiments, particularly useful core layers 50 can be described by their T-block strength. Accordingly, in certain embodiments, the core layer can have a T-block strength of at least 2 MPa, at least 3 MPa, at least 4 MPa, at least 5 MPa, at least 6 MPa, or even at least 7 MPa.

In particular embodiments, the core layer 50 can be at least partly porous such that the adhesive layer(s) 20,22 can at least partially impregnate the core layer 50. For example, certain fabric layers or foam layers can have a porosity such that the adhesive layer(s) 20,22 can partially impregnate the core layer.

In particular embodiments, the adhesive layer can include and particularly can be based on an acrylic resin. In very particular embodiments, the adhesive resin, such as an acrylic resin, can include a pressure sensitive adhesive (PSA) resin.

Particular examples of suitable pressure sensitive adhesive resins include, but are not limited to, adhesives based on general compositions of acrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends of the above.

In particular embodiments, the pressure sensitive adhesive resin can be based on general compositions of acrylates, such as poly(meth)acrylate, ethylacrylate, ethyl methacrylate, or combinations thereof. For example, the PSA acrylate can be a copolymer having monomers such as AA (acrylic acid), BA (n-butyl acrylate), CHMA (cyclohexyl methacrylate), IBA (isooctyl acrylate), IOA (isooctyl acrylate), MA (methyl acrylate), MAA (methacrylic acid), MMA (methyl methacrylate), EA (ethyl acrylate), and others.

In certain embodiments, the acrylate resin can contain an emulsion based acrylate PSA. In other embodiments, the acrylate resin can contain a solvent based acrylic PSA.

The pressure sensitive adhesive composition may contain additives including, but not limited to, tackifiers, plasticizers, fillers, antioxidants, stabilizers, pigments, diffusing materials, curatives, fibers, filaments, and solvents.

In certain embodiments, the adhesive resin can be present in the layer in an amount of at least 1 wt. %, at least 5 wt. %, at least 10 wt. %, at least 20 wt. %, at least 30 wt. %, at least 40 wt. %, at least 50 wt. %, or even at least 60 wt. % based on the total dry weight of the composition. In further embodiments, the adhesive resin can be present in the layer in an amount of no greater than 90 wt. %, no greater than 85 wt. %, or even no greater than 80 wt. % based on the total dry weight of the adhesive layer. Moreover, in certain embodiments, the adhesive resin can be present in the layer in an amount in a range of any of the minimum and maximum values provided above, such as in a range of 1 wt. % to 90 wt.5, or even 5 wt. % to 85 wt. %, based on the total dry weight of the composition.

As discussed above, the adhesive layer can comprise a first crosslinkable component. As used herein, the phrase “crosslinkable component” refers to a component which can form a crosslinked bond with another compound present in the composition, or with itself in an interpenetrated network (IPN), upon curing.

The first crosslinkable component can be in monomeric or polymeric form when combined with the acrylic resin and formed into an adhesive layer. In particular embodiments, the first crosslinkable component can be in monomeric form when combined with the acrylic resin.

In certain embodiments, the first crosslinkable component can form an interpenetrated network with itself upon curing. In other embodiments, the first crosslinkable component can form a crosslinked bond with another compound present in the adhesive layer. In still further embodiments, the first crosslinkable component can form either or both of a crosslinked bond with another compound present in the adhesive layer and form a interpenetrated network (IPN) upon curing.

In certain embodiments, the first crosslinkable component can be in the same phase as the acrylic resin described above. Put another way, in certain embodiments, the first crosslinkable component can not be in a separate phase from the acrylic resin. Put yet another way, in certain embodiments, the first crosslinkable component does not phase separate from the acrylic resin. As used herein the phrases “phase separate” or “not be in a separate phase” means that by differential scanning calorimetry (DSC) essentially no detectable thermal transition, such as a melting or glass transition temperature can be found for the pure crosslinkable component in the composition with acrylic resin. Some migration of the crosslinkable component from or throughout the layer can be tolerated, such as minor separation due to composition equilibrium or temperature influences, but the crosslinkable component does not migrate to the extent of phase separation between the acrylic resin and the crosslinkable component.

In certain embodiments, the first crosslinkable component can be non-volatile. For example, the first crosslinkable component can remain in the cured adhesive layer and will not substantially evaporate out of the adhesive layer during curing. A particular advantage of certain embodiments of the present disclosure is a non volatile first crosslinkable component, which can, in certain embodiments, also reduce the viscosity of the acrylic resin, depending of course on the particular type of acrylic resin employed and other components in the composition. Accordingly, in particular embodiments, the first crosslinkable component can provide a reduction in viscosity to the acrylic resin, and remain present and stable even under curing temperatures, and even maintain or improve the strength of the adhesive.

In particular embodiments, the first crosslinkable component can have at least one allyl group. In further embodiments, the first crosslinkable component can have at least two allyl groups.

In particular embodiments, the first crosslinkable component can contain a phthalate, such as a phthalate ester or an ester of phthalic acid.

In very particular embodiments, the first crosslinkable component can contain a diallyl phthalate polymer. In even further particular embodiments, the first crosslinkable component can contain diallyl orthophthalate.

In very particular embodiments, the first crosslinkable component can contain a compound according to formula (1) and/or formula (2):

CH2=CHCOOROOCCH═CH2 (1)

CH2=CHCH2OCOROCOCH2CH═CH2 (2)

wherein, R represents an aliphatic compound having from 1 to 12 carbon atoms, an ether group, an alicyclic hydrocarbon, or an aromatic hydrocarbon (having ortho-, iso-, or tere-structure).

In certain embodiments, the first crosslinkable component can be present in the adhesive layer in a significant, non additive amount. For example, traditional additives such as plasticizers that are included in an adhesive layers for adhesive tapes, and particularly structural bonding tapes, are present in amounts of less than about 3 wt. %, based on the total dry weight of the adhesive composition. While, in the present disclosure, the first crosslinkable component can be present in a greater amount.

In particular embodiments, the first crosslinkable component can be present in the adhesive layer in an amount of at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, or even at least about 25 wt. %, based on the total dry weight of the adhesive layer.

In further embodiments, the first crosslinkable component can be present in the adhesive layer in an amount of no greater than about 75 wt. %, no greater than about 70 wt. %, no greater than about 65 wt. %, no greater than about 60 wt. %, no greater than about 55 wt. %, no greater than about 50 wt. %, no greater than about 45 wt. %, no greater than about 40 wt. %, or even no greater than about 35 wt. %, based on the total dry weight of the adhesive layer.

Moreover, in certain embodiments, the first crosslinkable component can be present in the adhesive layer in a range of any of the minimum and maximum amounts described above, such as in a range of 3 wt. % to 75 wt. %, 5 wt. % to 70 wt. %, 10 wt. % to 65 wt. %, or even 20 wt. % to 75 wt. %.

In certain embodiments, the adhesive layer can further include a second crosslinkable component, which is different than the first crosslinkable component. In particular embodiments, the second crosslinkable component can form a crosslinked bond with the acrylic resin. In other particular embodiments, the second crosslinkable component does not form an interpenetrated network (IPN). Furthermore, in certain embodiments, the second crosslinkable component can form a crosslinked bond with the first crosslinkable component.

In certain embodiments, the second crosslinkable component can be present in the adhesive layer in an amount of at least about 0.1 wt. %, at least about 0.2 wt. %, at least about 0.5 wt. %, at least about 0.8 wt. %, or even at least about 1 wt. %, based on the total dry weight of the adhesive layer.

In certain embodiments, the second crosslinkable component can be present in the composition in an amount of not greater than about 10 wt. %, not greater than about 8 wt. %, not greater than about 7 wt. %, not greater than about 5 wt. %, or not greater than about 3%, or not greater than about 1%, based on the total dry weight of the adhesive layer.

Moreover, in certain embodiments, the second crosslinkable component can be present in the composition in an amount in a range of any of the minimum and maximum values provided above, such as in a range of 0.1 wt. % to 10 wt. %, 0.5 wt. % to 8 wt. %, or even 1 wt. % to 5 wt. %, based on the total dry weight of the adhesive layer.

In particular embodiments, the second crosslinkable component can be present in the adhesive layer in a weight percentage amount which is less than the weight percentage of first crosslinkable component, based on the total dry weight of the composition.

In particular embodiments, the second crosslinkable component can contain a structural adhesive resin. For example, in very particular embodiments, the second crosslinkable component can contain an epoxy based resin.

In certain embodiments, the second crosslinkable component can begin or initiate crosslinking at a lower temperature than the first crosslinkable component, if both the first and the second crosslinking components are heat curable crosslinkable components. Put another way, the second crosslinkable component can have a cure temperature which is less than the first crosslinkable component.

In certain further embodiments, the second crosslinkable component can have a faster cure time than the first crosslinkable component. Cure time is a measure of the rate of formation of the crosslinked bonds during curing.

In certain embodiments, the composition can further include a heat resistant resin. The heat resistant resin can function to control the modulus of PSA resin to increase the heat resistance performance at high temperature (curing temperature), facilitate die-cut and other improvements.

In certain embodiments, classes of particular heat resistant resins can include elastomers. In particular embodiments, the elastomer can have a glass transition temperature of no greater than 100 degrees Celsius, no greater than 85 degrees Celsius, or even no greater than 70 degrees Celsius. In further embodiments, the elastomer can have a glass transition temperature of at least 0 degrees Celsius, at least 5 degrees Celsius, or even at least 10 degrees Celsius. Moreover, in particular embodiments, the elastomer can have a glass transition temperature in a range of any of the minimums and maximums provided above, such as in a range of from 10 degrees Celsius to 70 degrees Celsius.

In particular embodiments, the heat resistant resin can be based on acrylate, polyurethane (PU), a diallyl orthophthalate prepolymer, and others.

In certain embodiments, the heat resistant resin can not phase separate from the composition, as defined above.

In certain embodiments, the heat resistant resin can be present in the adhesive layer in an amount of at least about 1 wt. %, at least about 5 wt. %, or even at least about 10 wt. % based on the total dry weight of the composition. In further embodiments, the heat resistant resin can be present in the composition in an amount of no greater than 90 wt. %, no greater than 80 wt. %, or even no greater than 70 wt. % based on the total dry weight of the adhesive layer. Moreover, in certain embodiments, the heat resistant resin can be present in the adhesive layer in an amount in a range of any of the minimum and maximum values provided above, such as in a range of 1 wt. % to 90 wt. % based on the total dry weight of the adhesive layer.

In certain embodiments, the adhesive layer can further include a filler. The filler can function to increase the strength and hardness of the adhesive composition and control the viscosity, as compared to the same composition without the filler present.

In particular embodiments, suitable fillers can include silicon oxide, carbon black, hollow glass/ceramic beads, silica, titanium dioxide, solid glass/ceramic spheres, chalk or combinations thereof.

In certain embodiments, the filler can be present in the adhesive layer in an amount in a range of from about 0 to 10 wt. %, or even about 0.1 wt. % to about 5 wt. % based on the total dry weight of the adhesive layer.

The novel adhesive tapes disclosed in the present specification exhibit advantageous and synergistic physical and performance characteristics. For example, the novel compositions can contain an advantageous modulus, shelf-life, overlap shear strength, and others.

One characteristic of the novel adhesive layers described herein is its modulus. The modulus is a measure of the adhesive's ability to function as an adhesive in different temperature climates. The modulus can be measured according to the Modulus Test, the procedure for which is as follows:

The adhesive composition is prepared and measured for modulus at different temperatures. An ARES-G2 Rheometer available from TA Instruments is used as the testing device. The testing device is set to oscillatory shear mode, temperature ramp is from −55 degrees Celsius to 150 degrees Celsius, with a temperature ramp rate of 5 degrees Celsius per minute and with an oscillatory frequency of a 1 Hz.

A particular advantage of embodiments the present disclosure is the low modulus of the adhesive that was able to be achieved, throughout a broad range of temperatures, and particularly low temperatures. As will be further illustrated in the Examples below, embodiments of the adhesive of the present disclosure exhibit a low modulus at low temperatures, and throughout a broad temperature range. Accordingly, such adhesive tapes can exhibit improved initial tack, particularly at low temperatures.

In certain embodiments, the adhesive layer can have a modulus of no greater than 10⁶ G′(Pa) at a temperature of 15 degrees Celsius, 10 degrees Celsius, 5 degrees Celsius, 0 degrees Celsius, −5 degrees Celsius, −10 degrees Celsius or even −50 degrees Celsius as measured according to The Modulus Test.

In further embodiments, the adhesive layer can have a modulus of no greater than 10⁶ G′(Pa), no greater than 10⁵ G′(Pa), or even no greater than 10⁴ G′(Pa) at 20 degrees Celsius as measured according to The Modulus Test.

In further embodiments, the adhesive layer can have a modulus of no greater than 10⁶ G′(Pa) at a temperature of not greater than 20 degrees Celsius, not greater than 10 degrees Celsius, not greater than 0 degrees Celsius, not greater than −10 degrees Celsius, not greater than −20 degrees Celsius, not greater than −30 degrees Celsius, or even not greater than −50 degrees Celsius as measured according to The Modulus Test.

In further embodiments, the adhesive layer can have a modulus of no greater than 10⁶ G′(Pa) across an entire temperature range of −25 degrees Celsius to 125 degrees Celsius, −15 degrees Celsius to 100 degrees Celsius, 0 degrees Celsius to 100 degrees Celsius, or even 15 degrees Celsius to 100 degrees Celsius.

Another parameter that illustrates the substantial improvements of the present disclosure is the ability of the adhesive tape to posses a high level of initial tack across a broad temperature range, and particular at low temperatures. The initial tack of the adhesive tape can be determined by evaluating the modulus of the composition at different temperatures and/or through experimental measurements.

To determine the initial tack of an adhesive tape by evaluating the modulus, The Modulus Test as described above can be performed. As used herein, a sample is said to have an initial tack as determined by modulus at a particular temperature if the sample has a modulus of less than about 3×10⁶ Pa at 1 Hz at that temperature.

Accordingly, embodiments of the present disclosure can exhibit initial tack at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Another way to quantify initial tack is experimental measurement. To measure the initial tack by experimental measurement, a test temperature is selected and the sample is adhered to a steel plate and then placed horizontally into a chamber able to control temperatures to the desired testing temperature. The sample and steel plate are held at the testing temperature for 1 hour, and then a second steel plate is adhered to the free side of the sample. The first steel plate is then lifted vertically. If the second steel plate does not decouple from the first steel plate, the sample is considered to have passed the initial tack experimental measurement test at that temperature.

Accordingly, embodiments of the present disclosure can exhibit initial tack as determined by experimental measurement at an application temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

A particular advantage of the present disclosure is the ability of the adhesive tape to exhibit initial tack at low application temperatures. State of the art structural adhesive tapes fail to exhibit an initial tack below about 30 degrees Celsius. It is to be understood that the adhesive composition can exhibit initial tack at other temperatures other than the specific temperature provided above, and in certain embodiments, can exhibit initial tack at temperatures ranging from at least −45 degrees Celsius to over 150 degrees Celsius.

Another parameter that describes an advantageous characteristic of the embodiments of the novel adhesive tapes described herein is its improved shelf life. The shelf life can be measured by the Shelf Life Test. To count as having shelf life, two criteria must be met. The first is the time it takes for the adhesive to lose initial tack as defined above after storage at a specified time at room temperature.

The second is the time it takes for the overlap shear strength to reach 85% of its initial value after storage at room temperature. The Shelf Life measurement used being the shorter of the two times.

A particular advantage of embodiments of the present disclosure is significantly improved shelf life of the adhesive tape. In fact, the current inventors surprisingly discovered adhesive tapes which could have significantly improved shelf life without sacrificing other qualities, such as overlap shear strength, pressure sensitive performance, displacement, and/or others.

In certain embodiments, the adhesive tape can have a shelf-life of at least 4 months, at least 5 months, at least 6 months, at least 7 months, at least 8 months, at least 9 months, at least 10 months, at least 11 months, or even at least 12 months as measured according to the Shelf Life Test.

Another parameter that describes an advantageous characteristic of embodiments of the novel adhesive tapes described herein is a high overlap shear strength after curing. Overlap shear strength can be measured by the Lap Shear Test as outlined below.

The overlap shear strength and displacement of the tape being tested is determined by adhering a 20 mm by 20 mm strip (0.5 mm thick) of the tape between overlapping ends of steel panels (available from Advanced Coatings Technology; Hillsdale, Mich.) measuring 25 mm by 75 mm, such that the free ends of the panels extend in opposite directions. The composite is pressed together with 15 PSI pressure for 5 seconds. Then the composite is then hung in an oven with a target weight and cured. The sample is then cooled to room temperature and the displacement of the tape can be measured below steel panel from original place. Following, the sample is tested for overlap shear strength by extending the free ends of the panel in the jaws of an INSTRON Tensile Tester (model number 4501, available from Instron Corp., of Canton, Mass.) and separating the jaws at a rate of 300 mm/min. The overlap shear strength value of the cured tape, thus obtained, is recorded in MegaPascals (MPa).

In certain embodiments, the adhesive tape can have an overlap shear strength of at least 6 MPa, at least 7 MPa, at least 8 MPa, at least 9 MPa, at least 10 MPa, at least 11 MPa, at least 12 MPa, or even at least 13 MPa as measured according to the Lap Shear Test.

Another characteristic of the adhesive tape is pluck adhesion strength, and particularly pluck adhesion strength after ageing. The pluck adhesion test measures the ability of the adhesive tape to hold under a vertical pluck. To perform the pluck adhesion test, a sample is provided, adhered between the pluck mechanism and a substrate. Force is applied in a vertical pluck direction with an Instron Tensile Tester. If 700 N force holds for 5 s in the vertical pluck, the pluck adhesion strength is higher than 1.08 MPa.

Accordingly, adhesive tapes according to certain embodiments of the present disclosure can have a pluck adhesion strength of at least 1.08 Mpa.

Furthermore, embodiments of the adhesive tape of the present disclosure can have a pluck adhesion strength of at least 1.08 Mpa after ageing. To age the adhesive tape, 10 successive cycles were performed as follows: (1) 16 hours at 40 degrees Celsius and 95 RH; (2) four hours at −30 degrees Celsius; and (3) four hours at 70 degrees Celsius and 95% RH.

A particular advantage of the present disclosure is the ability to meet a desirable pluck adhesion strength, such as at least 1.08 MPa, in combination with the improved parameters such as shelf life and low application temperatures. Attempts to increase parameters such as shelf life and low application temperatures resulted in a significant decrease in parameters such as pluck adhesion. In contrast, embodiments of the present disclosure can exhibit a synergistic performance of properties such as pluck adhesion strength, shelf life and low application temperatures.

Yet another characteristic of the adhesive tape is the parallel torque at the adhesion break point. To test the parallel torque, a torque wrench is used and the sample is bonded between two T-shaped aluminum blocks. One block is fixed firmly below and the torque wrench is used to hold the top block and switch, record the torque at breaking as the final value. The adhesion areas used is 25.4 mm×25.4 mm. The results are reported as Nm.

Accordingly, embodiments of the present disclosure can have a parallel torque at the adhesion break point of at least 10 Nm, at least 20 Nm, at least 40 Nm, at least 50 Nm, at least 60 Nm, at least 70 Nm, at least 80 Nm, at least 90 Nm, or even at least 100 Nm as measured to the parallel torque test described above.

In certain embodiments, the adhesive tape can have an advantageous cure temperature. When the adhesive tape is being used, the adhesive tape is applied between two substrates and cured. In particular embodiments, the adhesive tape can have a cure temperature of no greater than 165 degrees Celsius, no greater than 160 degrees Celsius, or even no greater than 155 degrees Celsius. In further embodiments, the adhesive tape can have a cure temperature of at least 120 degrees Celsius, at least 125 degrees Celsius, or even at least 130 degrees Celsius. Moreover, the adhesive tape can have a cure temperature in a range of any of the minimums and maximums provided above, such as in a range of from 120 degrees Celsius to 165 degrees Celsius, or even 125 degrees Celsius to 155 degrees Celsius. In very particular embodiments, the adhesive tape can have a cure temperature of about 150 degrees Celsius.

In certain embodiments, the adhesive tape can have an advantageous cure time. For example, in particular embodiments, the adhesive tape can have a cure time of no greater than 40 minutes, no greater than 35 minutes, or even no greater than 30 minutes. In further embodiments, the adhesive tape can have a cure time of at least 5 minutes, at least 10 minutes, or even at least 15 minutes. Moreover, the adhesive tape can have a cure time in a range of any of the minimums and maximums provided above, such as in a range of from 5 minutes to 40 minutes, 10 minutes to 35 minutes, or even 15 minutes to 30 minutes.

In further embodiments, the adhesive tape can have an advantageous combination of the cure temperature to cure time. For example, a particular advantage of the present disclosure is to quickly cure the adhesive tape at a relatively low temperature. As is understood in the art, in general, as the cure temperature increases, the cure time decreases. Accordingly, the adhesive tape can have a combination of the cure temperatures and cure times provided above. For example, the adhesive tape can have a cure temperature in a range of from 120 degrees Celsius to 160 degrees Celsius and a cure time in a range of from 10 minutes to 30 minutes.

In certain embodiments, the adhesive tape can have a desirable ratio of the cure temperature to the cure time. As used herein, the ratio of the cure temperature to the cure time is defined by dividing the cure temperature measured in degrees Celsius by the cure time measure in minutes. For example, if an adhesive tape has a cure temperature of 150 degrees Celsius and a cure time of 15 minutes, the ratio of the cure temperature to the cure time would be 10 degrees Celsius/minute. As yet another example, if the adhesive tape has a cure temperature of 120 degrees Celsius and a cure time of 30 minutes, the ratio of the cure temperature to the cure time would be 4 degrees Celsius/minute. Accordingly, in particular embodiments, the adhesive tape can have a ratio of the cure temperature to cure time of at least 4 degrees Celsius/minute, at least 5 degrees Celsius/minute, or even at least 6 degrees Celsius/minute. In further embodiments, the adhesive tape can have a ratio of the cure temperature to cure time of no greater than 13 degrees Celsius/minute, no greater than 12 degrees Celsius/minute, or even no greater than 11 degrees Celsius/minute. Moreover, the adhesive tape can have a ratio of the cure temperature to cure time in a range of any of the minimums and maximums provided above, such as in a range of from 4 degrees Celsius/minute to 13 degrees Celsius/minute, 5 degrees Celsius/minute to 12 degrees Celsius/minute, or even 6 degrees Celsius/minute to 11 degrees Celsius/minute.

It is to be understood that the cure temperature and cure time of the adhesive tape are inherent characteristic of the adhesive tape that can be measured and compared. As used herein, the cure temperature is defined to be the temperature which can be applied to the adhesive tape after sandwiching between two substrates and takes no greater than 40 minutes to cure. One is to characterize the curing by adhesive strength. Embodiments of the present disclosure are directed to adhesive tapes exhibiting a very high adhesive strength after curing. Thus, according to one method, the adhesive tape can be considered cured when the adhesive tape exhibits an adhesion strength of at least 6 MPa after initial application of the curing temperature. Similarly, the cure time is defined to be the time period beginning with the application of the curing temperature, and ending when the adhesive tape exhibits an adhesion strength of at least 6 Mpa.

It should be understood to those skilled in the art that this 6 MPa value is adhesive tape dependent. Other adhesive tapes could reach a time to cure whereby the adhesive strength would be less than 6 MPa due to the particular polymers employed to form the adhesive tapes. The definition of adhesive cure, as defined by an adhesive strength property (measured in units of force, MPa), is dependent on the adhesive tape.

Another way to determine when sufficient amount of curing has occurred to be considered “cured” according to the present disclosure is by measuring the modulus over time and determining the intersection of tangent lines in two distinct slope regions. For example, as is well understood in the art, the rate curing of an adhesive tape generally occurs rapidly in the beginning and significantly slows towards the end of the curing process and often requiring a long period of time to be technically considered a full cure. Accordingly, two distinct slope regions generally exist in a graph of the modulus over time during application of the cure temperature. The intersecting region of lines tangent to these distinct slope regions defines the curing time.

In further embodiments, and as discussed herein, embodiments of the novel adhesive tape can include a synergistic combination of the parameters/characteristics described above. For example, the adhesive tape can exhibit combinations of an advantageous overlap shear strength, an advantageous shelf-life, an advantageous modulus, and even all of the recited characteristics. Without wishing to be bound by theory, it is believed that these synergistic combinations of parameters have never before been able to be achieved.

In particular embodiments, the adhesive tape can be in the form of a structural bonding tape. A structural bonding tape is a tape that bonds on contact and when heat-cured develops a structural strength bond.

Accordingly, particular embodiments of the present disclosure are directed to an adhesive tape adapted to adhere a component to a rigid surface for an extended period of time, such as for at least 1 year, at least 2 years, at least 3 years, or even at least 4 years. The adhesive tape of any one of the preceding claims, wherein the adhesive tape is adapted to adhere a component to a rigid surface.

For example, a primary application of the adhesive tape described herein is an adhesive tape which can adhere a review mirror or a rain sensor to a windshield. In other applications, the review minor assembly can include a coupler, which is adhered to the windshield and can removably couple to the rearview minor. In such applications, the component, i.e. review mirror or rain sensor, can be adapted to be adhered to the substrate, such as a windshield, such that gravity applies a detaching force to the adhesive bond or bonds in the adhesive layer or layers. Adhesive tapes that do not develop the needed structural integrity after curing and possessing high enough initial tack can hold a component such as a review minor or rain sensor securely and permanently in place are not adapted to be adhere a component to a surface such when gravity is applying a detaching force to the adhesive bond(s).

Furthermore, in certain embodiments, the adhesive tape can be adapted to adhere a component to a transparent surface. For example, suitable transparent surfaces can include, but are not limited to, a polymeric surface or a glass surface.

Accordingly, certain other embodiments of the present disclosure are directed to an assembly containing a substrate, such as a windshield, a component, such as a rearview minor, coupler, or rain sensor, and an adhesive tape of any one of the preceding claims disposed between and adhering the component to the windshield. An assembly comprising a windshield, a rearview mirror, and the adhesive tape of any one of the preceding claims, and wherein the rearview mirror is attached to the windshield via the article.

### Examples

Three samples were prepared and tested in comparison to commercially structural bonding tapes available from 3M tape.

Samples A, B, and C were prepared by combining the components identified in Table 1 below and forming into a tape containing a single layer of the adhesive.

TABLE 1
Formulation of Samples

| Component | Sample A | Sample B | Sample C |
|---|---|---|---|
| PSA | 45 wt. % | 60 wt. % | 0 wt. % |
| | (Resin 3766, | (Resin 3766, | |
| | Henkel) | Henkel) | |
| Heat Resistant Resin | 22.5 wt. % | 0 wt. % | 59 wt. % |
| First Crosslinkable | 28.4 wt. % | 37 wt. % | 37 wt. % |
| Component (diallyl | | | |
| orthophthalate) | | | |
| Second Crosslinkable | 0 wt. % | 1.2 wt. % | 0 wt. % |
| Component (Epoxy) | | | |
| Filler (silicone oxide) | 2 wt. % | 2 wt. % | 2 wt. % |
| Substrate | Glass, | Glass, | Glass, |
| Arrangement | PET, steel, | PET, steel, | PET, steel, |
| | aluminum | aluminum | aluminum |

Samples A-C and the comparative 3M commercial product were measured for Modulus. As discussed within this document, adhesive tapes described herein desire to have a high conformability before curing. Accordingly, to obtain high conformability, the modulus before curing should be low, such as less than 3×10⁶ Pa at 1 Hz, under application conditions.

The modulus was tested using an ARES-G2 Rheometer available from TA in oscillatory shear mode, with a temperature ramp from −55 degrees Celsius to 150 degrees Celsius at 5 degrees Celsius per minute and at 1 Hz.

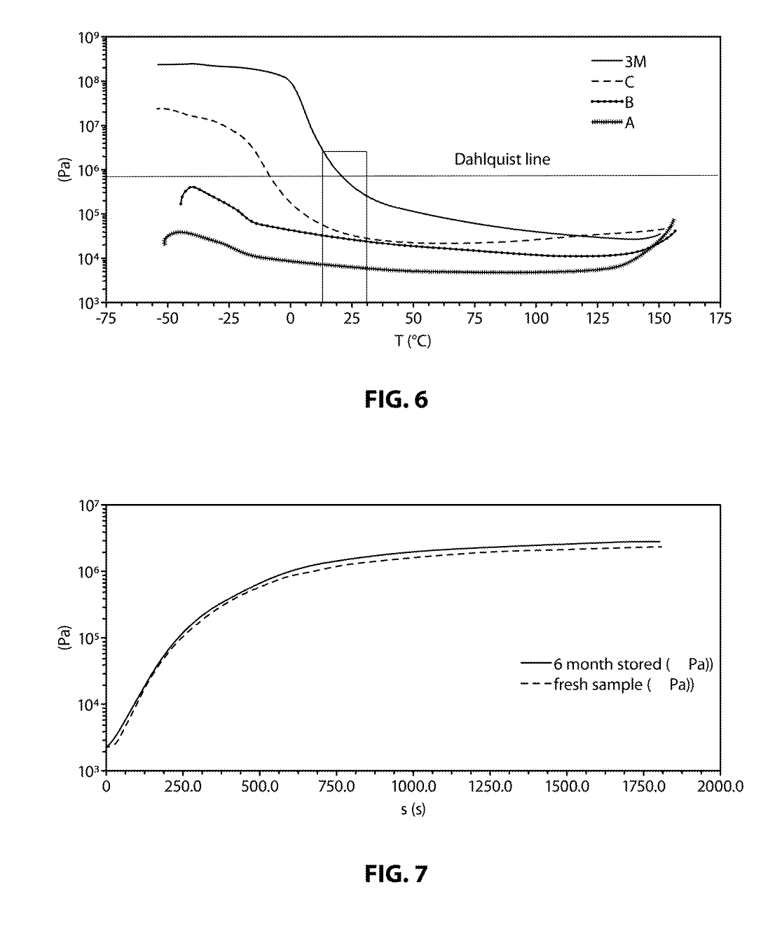

The results are reported in FIG. 6 which contains a graph of the modulus across the temperature range tested. As illustrated in FIG. 6, each of Samples A-C outperformed in the 3M comparative product, particularly at low temperatures, such as less than about 25 degrees Celsius.

As described above, the initial tack can be indirectly determined by the modulus of the sample at a given temperature. If the modulus is below 3×10⁶ Pa at 1 Hz at the specified temperature, the sample is considered to have initial tack as determined by modulus analysis. Referring to FIG. 6 which illustrates the modulus of various samples in comparison to the comparative modulus, it is seen that samples A and B have initial tack across a much wider temperature range, and particularly at lower temperatures, such as less than about 25 degrees Celsius.

Samples A-C and the comparative 3M sample were then tested for initial tack by experimental measurement at −15 degrees Celsius, 0 degrees Celsius, and 15 degrees Celsius to illustrate the effect the modulus has on the ability for the adhesive article exhibit a suitable initial tack. To measure the initial tack, the sample is adhered to a steel plate and then placed horizontally into a chamber able to control temperatures to the desired testing temperature. The sample and steel plate are held at the testing temperature for 1 hour, and then a second steel plate is adhered to the free side of the sample. The first steel plate is then lifted vertically. If the second steel plate does not decouple from the first steel plate, the sample is considered to have passed the initial tack test.

TABLE 2
Initial Tack Test Results

| | A | B | C | 3M |
|---|---|---|---|---|
| 15 Degrees Celsius | Pass | Pass | Pass | Pass |
| 0 Degrees Celsius | Pass | Pass | Pass | Fail |
| −15 Degrees Celsius | Pass | Pass | Fail | Fail |

The results indicate that Samples A, B, and C show improved initial tack at lower temperatures, which is in agreement with the initial tack test by modulus as outlined in Example 2a.

Sample B was tested for its shelf life according to the rheology test method. To test for shelf life under a rheology test, the sample is initially tested for Modulus during curing, and tested again for Modulus after aging at room temperature and humidity for 6 months. The sample is said to have shelf life at the particular time frame and at the particular application temperature if the aged modulus closely correlates to the initial modulus. The results of the Rheology Shelf Life Tests are illustrated in FIG. 7. As can be seen, the aged sample's modulus closely correlates to the initial modulus, and thus sample B has a shelf life of at least 6 months.

Each of samples A-C and the comparative 3M samples were tested for shelf life according to an application test method. To test for shelf life under the application test method, a sample is adhered to a steel plate and the placed horizontally into an oven at 75 degrees Celsius. After dwelling at 75 degrees Celsius for 8 hours, a second steel plate is adhered to the sample, thereby sandwiching the sample between the two steel plates. The results of the Application Shelf Life Test is illustrated in Table 3.

TABLE 3
Application Shelf Life Test Results

| | | | | 3M |
|---|---|---|---|---|
| Storage temp | Sample A | Sample B | Sample C | (comparative) |
| 75 C. | <20 hours | >30 hours | >30 hours | >20, but <30 |
| | | | | hours |
| Room temp | <3 months | >12 months | >12 months | <6 month |

As can be seen, samples B and C have a longer shelf life than the 3M comparative product as measured according to the Application Shelf Life Test.

Pluck Adhesion After Ageing and Parallel Torque.

Samples A-C, the comparative 3M sample, and various multi-layer samples were produced and tested for their pluck adhesion strength after ageing and parallel torque. For the pluck adhesion strength test, the samples were aged by performing 10 successive cycles were performed as follows: (1) 16 hours at 40 degrees Celsius and 95 RH; (2) four hours at −30 degrees Celsius; and (3) four hours at 70 degrees Celsius and 95% RH. The test procedures for each test were performed as outline above.

Samples D included the following structure: Sample A/PET film/Sample A.

Sample E included the following structure: Sample B/TPU film/Sample B.

Sample F included the following structure: Sample C/PU film/Sample C.

Sample G included the following structure: Sample B/PET film/Sample B.

Sample H included the following structure: Sample C/PET film/Sample C.

Sample I included the following structure: Sample A/Sample A/Sample A.

Sample J included the following structure: Sample B/Sample B/Sample B.

Sample K included the following structure: Sample C/Sample C/Sample C.

The following results were obtained.

TABLE 4
Aged Pluck Adhesion and Parallel Torque.

| | Pluck | Parallel |
|---|---|---|
| Sample | Adhesion | Torque |
| Sample A | >1.08 MPa | >100 Nm |
| Sample B | >1.08 MPa | 38 Nm |
| Sample C | >1.08 MPa | 38 Nm |
| Sample D | >1.08 MPa | 66 Nm |
| Sample E | >1.08 MPa | — |
| Sample F | >1.08 MPa | — |
| Sample G | — | 16 Nm |
| Sample H | — | 15 Nm |
| Sample I | — | 96 Nm |
| Sample J | — | 15 Nm |
| Sample K | — | 35 Nm |
| 3M | >1.08 MPa | 45 Nm |
| (Comparative) | | |

Sample L was prepared and tested in comparison to a Comparative Sample M including a commercial structural bonding tape 9214 available from 3M.

Sample L was prepared by combining the components identified in Table 5 below and forming into a tape containing a single layer of the adhesive.

TABLE 5

| Component | Sample L | |
|---|---|---|
| PSA | 0 | wt. % |
| Heat Resistant Resin | 59 | wt. % |
| First Crosslinkable | 12/12/12 | wt. % |
| Component (diallyl | | |
| orthophthalate/diallyl | | |
| terephthalate/SR504 | | |
| from Sartomer) | | |
| Second Crosslinkable | 0 | wt. % |
| Component (Epoxy) | | |
| Filler (silicone oxide) | 2 | wt. % |

| | |
|---|---|
| Substrate | Glass, steel, |
| Arrangement | aluminum |

An assembly was created using each Sample L and M wherein an aluminum block was bonded to a steel plate using the given sample adhesive. The assembly was cured at 145° C. for 25 minutes and then aged using Aging Condition 1 and then Aging Condition 2. Aging Condition 1 includes 10 cycles of (a) 12 hours (h) at 40° C., 95 RH; (b) 1 h at 40° C., 95 RH→−30° C.; (c) 4 h at −30° C.; (d) 2 h at −30° C.→70° C., 95 RH; (e) 4 h at 70° C., 95 RH; and (f) 1 h at 70° C., 95 RH→40° C., 95 RH. Aging Condition 2 includes 1 cycle of (a) 168 h at 70° C., 100 RH; and (b) 16 h at −20° C.

To test the parallel torque, a torque spanner was coupled to the block and rotated at 1 rad/s. The torque value was measured when the adhesive broke. The adhesion area used was 625 mm². The results are reported as Nm. The following results provided in Table 6 were obtained.

TABLE 6
Parallel Torque

| | Aging Condition 1 | Aging Condition 2 | |
|---|---|---|---|
| | Parallel Torque | Parallel Torque | |
| Sample | (Nm) | (Nm) | |
| Sample L | >100 Nm | >100 | Nm |
| Comparative Sample M | >100 Nm | 85 ± 5 | Nm |

Based on the results of Table 6, the Sample L performed at least as well as Comparative Sample M after Aging Condition 1 and significantly outperformed Comparative Sample M after Aging Condition 2.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. An adhesive tape comprising an adhesive layer comprising:
a. an acrylic based pressure sensitive adhesive resin; and
b. a first crosslinkable component, wherein the first crosslinkable component is present in the adhesive layer in a significant amount.

Item 2. An adhesive tape comprising an adhesive layer comprising:
a. an acrylic based pressure sensitive adhesive resin; and
b. a first crosslinkable component, wherein the first crosslinkable is adapted to form a crosslinked inter penetrated network (IPN) upon curing.

Item 3. An adhesive tape comprising an adhesive layer comprising:
a. an acrylic based pressure sensitive adhesive resin; and
b. a first crosslinkable component;
c. wherein the first crosslinkable component does not form a separate phase from the acrylic resin.

Item 4. An adhesive tape comprising an adhesive layer comprising:
a. an acrylic based pressure sensitive adhesive resin; and
b. a first crosslinkable component comprising diallyl orthophthalate in an amount of at least about 5 wt %, based on the total dry weight of the adhesive layer.

Item 5. An adhesive tape comprising an adhesive layer comprising:
a. a pressure sensitive adhesive resin;
b. a first crosslinkable component; and
c. a second crosslinkable component,
   wherein the first crosslinkable component has a greater weight percentage in the adhesive layer than the second crosslinkable component, based on the total dry weight of the adhesive layer,
   wherein the first crosslinkable component is different than the second crosslinkable component, and
   wherein the second crosslinkable component has a lower cure temperature than the first crosslinkable component.

Item 6. An adhesive tape comprising an adhesive layer comprising:
a. a pressure sensitive adhesive resin; and
b. a crosslinkable component;
   wherein the adhesive tape has at least two of the following characteristics:
      an overlap shear strength of greater than 8 MPa as measured according to the Lap Shear Test after aging of at least 4 months;
      a pressure sensitive performance of not greater than 10⁶ G′(Pa) at a temperature of not greater than 20 degrees Celsius; and/or
      a shelf life of at least 6 months as measured according to the Shelf Life modulus or experimental test.

Item 7. An adhesive tape comprising:
a. an adhesive layer, wherein the adhesive layer comprises an acrylic resin and a first crosslinkable component;
b. a core layer, wherein the second layer has a greater thickness than the adhesive layer, wherein the second layer forms a core of the article; and
c. a second adhesive layer, wherein the third layer comprises an acrylic resin and a first crosslinkable component.

Item 8. The adhesive tape of any one of the preceding items, wherein the adhesive tape is a transfer tape comprising the adhesive layer and at least one removable liner.

Item 9. The adhesive tape of any one of the preceding items, wherein the adhesive tape comprises an adhesive layer, a core layer, and a second adhesive layer, wherein the core layer is disposed between the adhesive layer and the second adhesive layer.

Item 10. The adhesive tape of any one of the preceding items, wherein the adhesive layer directly contacts the core layer on a first major surface, and wherein the second adhesive layer directly contacts the core layer on a second major surface, and wherein the first major surface is opposite the second major surface on the core layer.

Item 11. The adhesive tape of any one of the preceding items, wherein the adhesive layer forms an outer layer of the adhesive tape.

Item 12. The adhesive tape of any one of the preceding items, wherein the second adhesive layer forms an outer layer of the adhesive tape.

Item 13. The adhesive tape of any one of the preceding items, wherein the adhesive layer and the second adhesive layer form opposing outer layers of the adhesive tape.

Item 14. The adhesive tape of any one of the preceding items, wherein the second adhesive layer comprises an acrylic resin and a crosslinkable component.

Item 15. The adhesive tape of any one of the preceding items, wherein the adhesive layer and the second adhesive layer are formed from the same type of composition.

Item 16. The adhesive tape of any one of the preceding items, wherein the adhesive layer and the second adhesive layer are formed from a different type of composition.

Item 17. The adhesive tape of any one of the preceding items, wherein the adhesive layer has an average thickness of no greater than 2 mm, no greater than 1.5 mm, no greater than 1 mm, less than 0.6 mm, no greater than 0.55 mm, no greater than 0.50 mm, or even no greater than 0.4 mm.

Item 18. The adhesive tape of any one of the preceding items, wherein the adhesive layer has an average thickness of at least 0.001 mm, at least 0.01 mm, or even at least 0.05 mm.

Item 19. The adhesive tape of any one of the preceding items, wherein the adhesive tape has an average thickness of no greater than 25 mm, no greater than 22 mm, no greater than 20 mm, no greater than 18 mm, no greater than 16 mm, no greater than 15 mm, no greater than 14 mm, no greater than 13 mm, no greater than 12 mm, or even no greater than 11 mm.

Item 20. The adhesive tape of any one of the preceding items, wherein the adhesive tape has an average thickness of at least 0.01 mm, at least 0.05 mm, or even at least 0.1 mm.

Item 21. The adhesive tape of any one of the preceding items, wherein the core layer has an average thickness of at least 0.001 mm, at least 0.01 mm, at least 0.05 mm, or even at least 0.1 mm.

Item 22. The adhesive tape of any one of the preceding items, wherein the core layer has an average thickness of no greater than 22 mm, no greater than 20 mm, no greater than 18 mm, no greater than 16 mm, no greater than 15 mm, no greater than 14 mm, no greater than 13 mm, no greater than 12 mm, no greater than 11 mm, no greater than 10 mm, no greater than 9 mm, no greater than 8 mm, or even no greater than 7 mm.

Item 23. The adhesive tape of any one of the preceding items, wherein the second adhesive layer has an average thickness of no greater than 2 mm, no greater than 1.5 mm, no greater than 1 mm, less than 0.6 mm, no greater than 0.55 mm, no greater than 0.50 mm, or even no greater than 0.4 mm.

Item 24. The adhesive tape of any one of the preceding items, wherein the second adhesive layer has an average thickness of at least 0.001 mm, at least 0.01 mm, or even at least 0.05 mm.

Item 25. The adhesive tape of any one of the preceding items, wherein the core layer comprises a sheet material.

Item 26. The adhesive tape of any one of the preceding items, wherein the core layer comprises a film layer, a foamed layer, a fabric layer such as a woven or nonwoven fabric layer, or combinations thereof.

Item 27. The adhesive tape of any one of the preceding items, wherein the core layer has a shear strength of at least 2 MPa, at least 3 MPa, at least 4 MPa, at least 5 MPa, at least 6 MPa, or even at least 7 MPa.

Item 28. The adhesive tape of any one of the preceding items, wherein the core layer has a T-block strength of at least 2 MPa, at least 3 MPa, at least 4 MPa, at least 5 MPa, at least 6 MPa, or even at least 7 MPa.

Item 29. The adhesive tape of any one of the preceding items, wherein the adhesive layer and/or the second adhesive layer at least partially impregnates the core layer.

Item 30. The adhesive tape of any one of the preceding items, wherein the adhesive tape comprises a multi-layer structure, comprising at least two adhesive layers.

Item 31. The adhesive tape of any one of the preceding items, wherein the adhesive tape consists essentially of a single adhesive layer.

Item 32. The adhesive tape of any one of the preceding items, wherein the adhesive tape is essentially devoid of a substrate layer.

Item 33. The adhesive tape of any one of the preceding items, wherein the adhesive tape further comprises a release liner disposed adjacent the adhesive layer.

Item 34. The adhesive tape of any one of the preceding items, wherein the adhesive tape further comprises a release liner disposed adjacent the second adhesive layer.

Item 35. The adhesive tape of any one of the preceding items, wherein the liner is adapted to be removed before the adhesive layer is cured.

Item 36. The adhesive tape of any one of the preceding items, wherein the first crosslinkable component has at least one allyl group.

Item 37. The adhesive tape of any one of the preceding items, wherein the first crosslinkable component has at least two allyl groups.

Item 38. The composition of any one of the preceding items, wherein the first crosslinkable component comprises a phthalate (phthalate esters, esters of phtalic acid, structure).

Item 39. The adhesive tape of any one of the preceding items, wherein the first crosslinkable component comprises diallyl orthophthalate.

Item 40. The adhesive tape of any one of the preceding items, wherein the first crosslinkable component is non-volatile.

Item 41. The adhesive tape of any one of the preceding items, wherein the first crosslinkable component is non-volatile and wherein the first crosslinkable component provides a reduction in viscosity to the acrylic resin.

Item 42. The adhesive tape of any one of the preceding items, wherein the first crosslinkable component has a general formula 1 or 2:

CH2=CHCOOROOCCH═CH2 (1)

CH2=CHCH2OCOROCOCH2CH═CH2 (2)
wherein, R represents an aliphatic compound having from 1 to 12 carbon atoms, an ether group, an alicyclic hydrocarbon, or an aromatic hydrocarbon (having ortho-, iso-, or tere-structure).

Item 43. The adhesive tape of any one of the preceding items, wherein the first crosslinkable component is present in the adhesive layer in an amount of at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, or even at least about 25 wt. %, based on the total dry weight of the adhesive layer.

Item 44. The adhesive tape of any one of the preceding items, wherein the first crosslinkable component is present in the adhesive layer in an amount of no greater than about 75 wt. %, no greater than about 70 wt. %, no greater than about 65 wt. %, no greater than about 60 wt. %, no greater than about 55 wt. %, no greater than about 50 wt. %, no greater than about 45 wt. %, no greater than about 40 wt. %, or even no greater than about 35 wt. %, based on the total dry weight of the adhesive layer.

Item 45. The adhesive tape of any one of the preceding items, wherein the first crosslinkable component does not form a separate phase from the acrylic resin.

Item 46. The adhesive tape of any one of the preceding items, wherein the first crosslinkable component is in the same phase as the acrylic resin.

Item 47. The adhesive tape of any one of the preceding items, wherein the composition further comprises a second crosslinkable component, wherein the first crosslinkable component is different than the second crosslinkable component.

Item 48. The adhesive tape of any one of the preceding items, wherein the second crosslinkable component comprises a structural adhesive resin.

Item 49. The adhesive tape of any one of the preceding items, wherein the second crosslinkable component is present in the adhesive layer in an amount of at least about 0.1 wt. %, at least about 0.2 wt. %, at least about 0.5 wt. %, at least about 0.8 wt. %, or at least about 1 wt. %, based on the total dry weight of the adhesive layer.

Item 50. The adhesive tape of any one of the preceding items, wherein the second crosslinkable component is present in the adhesive layer in an amount of not greater than about 10 wt. %, not greater than about 8 wt. %, not greater than about 7 wt. %, not greater than about 5 wt. %, or not greater than about 3%, or not greater than about 1%, based on the total dry weight of the adhesive layer.

Item 51. The adhesive tape of any one of the preceding items, wherein the second crosslinkable component is present in the adhesive layer in a weight percentage amount of less than the first crosslinkable component.

Item 52. The adhesive tape of any one of the preceding items, wherein the second crosslinkable component comprises an epoxy, phenolic aldehyde, urea formaldehyde, alkyd resin, urethane, or combinations thereof.

Item 53. The adhesive tape of any one of the preceding items, wherein the second crosslinkable component begins crosslinking at a lower temperature than the first crosslinkable component.

Item 54. The adhesive tape of any one of the preceding items, wherein the acrylic resin comprises a PSA resin.

Item 55. The adhesive tape of any one of the preceding items, wherein the acrylic resin comprises an acrylate resin.

Item 56. The adhesive tape of any one of the preceding items, wherein the acrylic resin comprises poly(meth)acrylate, ethylacrylate, ethyl methacrylate, or combinations thereof.

Item 57. The adhesive tape of any one of the preceding items, wherein the acrylic resin comprises an emulsion based acrylic PSA.

Item 58. The adhesive tape of any one of the preceding items, wherein the adhesive layer comprises a solvent based acrylic PSA.

Item 59. The adhesive tape of any one of the preceding items, wherein the acrylic resin is present in the adhesive layer in an amount of at least 1 wt. %, at least 5 wt. %, at least 10 wt. %, at least 20 wt. %, at least 30 wt. %, at least 40 wt. %, at least 50 wt. %, or even at least 60 wt. %, based on the total dry weight of the adhesive layer.

Item 60. The adhesive tape of any one of the preceding items, wherein the acrylic resin is present in the adhesive layer in an amount of no greater than 90 wt. %, no greater than 85 wt. %, or even no greater than 80 wt. % based on the total dry weight of the adhesive layer.

Item 61. The adhesive tape of any one of the preceding items, wherein the adhesive layer further comprises a filler.

Item 62. The adhesive tape of any one of the preceding items, wherein the filler comprises silicon dioxide, or combinations thereof.

Item 63. The adhesive tape of any one of the preceding items, wherein the filler is present in the adhesive layer in an amount of at least 1 wt. %, based on the total dry weight of the adhesive layer.

Item 64. The adhesive tape of any one of the preceding items, wherein the filler is present in the adhesive layer in an amount of no greater than 10 wt. % or even no greater than 5 wt. %, based on the total dry weight of the adhesive layer.

Item 65. The adhesive tape of any one of the preceding items, wherein the adhesive layer further comprises a heat resistant resin.

Item 66. The adhesive tape of any one of the preceding items, wherein the heat resistant resin comprises acrylate, polyurethane (PU), a diallyl orthophthalate prepolymer, or combinations thereof.

Item 67. The adhesive tape of any one of the preceding items, wherein the heat resistant resin is present in the adhesive layer in an amount of at least about 1 wt. %, at least about 5 wt. %, or even at least about 10 wt. % based on the total dry weight of the adhesive layer.

Item 68. The adhesive tape of any one of the preceding items, wherein the heat resistant resin is present in the adhesive layer in an amount of no greater than 90 wt. %, no greater than 80 wt. %, or even no greater than 70 wt. % based on the total dry weight of the adhesive layer.

Item 69. The adhesive tape of any one of the preceding items, wherein the heat resistant resin is an elastomer.

Item 70. The adhesive tape of any one of the preceding items, wherein the heat resistant resin has a glass transition temperature of no greater than 100 degrees Celsius, no greater than 85 degrees Celsius, or even no greater than 70 degrees Celsius.

Item 71. The adhesive tape of any one of the preceding items, wherein the heat resistant resin has a glass transition temperature of at least 0 degrees Celsius, at least 5 degrees Celsius, or even at least 10 degrees Celsius.

Item 72. The adhesive tape of any one of the preceding items, wherein the heat resistant resin has a glass transition temperature in a range of from 10 degrees Celsius to 70 degrees Celsius.

Item 73. The adhesive tape of any one of the preceding items, wherein the adhesive layer has a modulus of no greater than 10⁶ G′(Pa) at a temperature of 15 degrees Celsius, 10 degrees Celsius, 5 degrees Celsius, 0 degrees Celsius, −5 degrees Celsius, −10 degrees Celsius or even −50 degrees Celsius as measured according to The Modulus Test.

Item 74. The adhesive tape of any one of the preceding items, wherein the adhesive layer has a modulus of less than 10⁶ G′(Pa), less than 10⁵ G′(Pa), or even less than 10⁴ G′(Pa) at 20 degrees Celsius as measured according to The Modulus Test.

Item 75. The adhesive tape of any one of the preceding items, wherein the adhesive layer has a modulus of less than 10⁶ G′(Pa) at a temperature of not greater than 20 degrees Celsius, not greater than 10 degrees Celsius, not greater than 0 degrees Celsius, not greater than −10 degrees Celsius, not greater than −20 degrees Celsius, not greater than −30 degrees Celsius, or even not greater than −50 degrees Celsius as measured according to The Modulus Test.

Item 76. The adhesive tape of any one of the preceding items, wherein the adhesive layer has a modulus of less than 10⁶ G′(Pa) across an entire temperature range of −25 degrees Celsius to 125 degrees Celsius.

Item 77. The adhesive tape of any one of the preceding items, wherein the adhesive tape has a shelf-life of at least 4 months, at least 5 months, at least 6 months, at least 7 months, at least 8 months, at least 9 months, at least 10 months, at least 11 months, or even at least 12 months as measured according to The Shelf Life Test.

Item 78. The adhesive tape of any one of the preceding items, wherein the adhesive tape has an overlap shear strength of at least 6 MPa, at least 7 MPa, at least 8 MPa, at least 9 MPa, at least 10 MPa, at least 11 MPa, at least 12 MPa, or even at least 13 MPa as measured according to The Lap Shear Test.

Item 79. The adhesive tape of any one of the preceding items, wherein the adhesive tape has at least two of the following characteristic:
a. an overlap shear strength of at least 8 MPa as measured according to The Lap Shear Test;
b. a shelf-life of at least 4 months as measured by The Shelf Life Test; and
c. an adhesive layer having a modulus, G′ (Pa), of less than 10⁶ G′(Pa) at 10 degrees Celsius.

Item 80. The adhesive tape of any one of the preceding items, wherein the adhesive tape has the following characteristic:
a. an overlap shear strength of at least 8 MPa as measured according to The Lap Shear Test;
b. a shelf-life of at least 4 months as measured by The Shelf Life Test; and
c. an adhesive layer having a modulus, G′ (Pa), of less than 10⁶ G′(Pa) at 10 degrees Celsius.

Item 81. The adhesive tape of any one of the preceding items, wherein the adhesive layer is a curable adhesive.

Item 82. The adhesive tape of any one of the preceding items, wherein adhesive tape has initial tack as determined by modulus at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Item 83. The adhesive tape of any one of the preceding items, wherein adhesive tape has initial tack as determined by experimental measurement at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Item 84. The adhesive tape of any one of the preceding items, wherein the adhesive tape is a structural bonding tape.

Item 85. The adhesive tape of any one of the preceding items, wherein the adhesive tape is adapted to adhere a component to a rigid surface.

Item 86. The adhesive tape of any one of the preceding items, wherein the adhesive tape is adapted to adhere a component to a transparent surface.

Item 87. The adhesive tape of any one of the preceding items, wherein the adhesive tape is adapted to adhere a component to a polymeric surface or a glass surface.

Item 88. The adhesive tape of any one of the preceding items, wherein the adhesive tape is adapted to adhere a component to a substrate, and wherein the component is adapted to be adhered to the substrate such that gravity applies a detaching force to the adhesive bond.

Item 89. The adhesive tape of any one of the preceding items, wherein the adhesive tape is adapted to adhere a coupler to couple a substrate.

Item 90. The adhesive tape of any one of the preceding items, wherein the coupler is adapted to couple to a rearview mirror.

Item 91. The adhesive tape of any one of the preceding items, wherein the adhesive tape is adapted to adhere a rearview minor or a rain sensor to a windshield.

Item 92. An assembly comprising a windshield, a rearview minor, and the adhesive tape of any one of the preceding items, and wherein the rearview minor is attached to the windshield via the adhesive tape.

Item 93. An assembly comprising a windshield, a rain sensor, and the adhesive tape of any one of the preceding items, and wherein the rain sensor is attached to the windshield via the adhesive tape.

Item 94. An assembly comprising a windshield, a rearview minor, a coupler, and the adhesive tape of any one of the preceding items, and wherein the coupler is attached to the windshield via the adhesive tape.

Item 95. The adhesive tape of any one of the preceding items, wherein the adhesive tape has a cure temperature of no greater than 165 degrees Celsius, no greater than 160 degrees Celsius, or even no greater than 155 degrees Celsius.

Item 96. The adhesive tape of any one of the preceding items, wherein the adhesive tape has a cure temperature of at least 120 degrees Celsius, at least 125 degrees Celsius, or even at least 130 degrees Celsius.

Item 97. The adhesive tape of any one of the preceding items, wherein the adhesive tape has a cure temperature in a range of from 120 degrees Celsius to 165 degrees Celsius, or even 125 degrees Celsius to 155 degrees Celsius

Item 98. The adhesive tape of any one of the preceding items, wherein the adhesive tape has a cure temperature of about 150 degrees Celsius.

Item 99. The adhesive tape of any one of the preceding items, wherein the adhesive tape has a cure time of no greater than 40 minutes, no greater than 35 minutes, or even no greater than 30 minutes.

Item 100. The adhesive tape of any one of the preceding items, wherein the adhesive tape has a cure time of at least 5 minutes, at least 10 minutes, or even at least 15 minutes.

Item 101. The adhesive tape of any one of the preceding claims, wherein the adhesive tape has a cure time in a range of from 5 minutes to 40 minutes, 10 minutes to 35 minutes, or even 15 minutes to 30 minutes.

Item 102. The adhesive tape of any one of the preceding items, wherein the adhesive tape has a cure temperature in a range of from 120 degrees Celsius to 160 degrees Celsius and a cure time in a range of from 10 minutes to 30 minutes.

Item 103. The adhesive tape of any one of the preceding items, wherein the adhesive tape has a ratio of the cure temperature to cure time of at least 4 degrees Celsius/minute, at least 5 degrees Celsius/minute, or even at least 6 degrees Celsius/minute.

Item 104. The adhesive tape of any one of the preceding items, wherein the adhesive tape has a ratio of the cure temperature to cure time of no greater than 13 degrees Celsius/minute, no greater than 12 degrees Celsius/minute, or even no greater than 11 degrees Celsius/minute.

Item 105. The adhesive tape of any one of the preceding items, wherein the adhesive tape has a ratio of the cure temperature to cure time in a range of from 4 degrees Celsius/minute to 13 degrees Celsius/minute, 5 degrees Celsius/minute to 12 degrees Celsius/minute, or even 6 degrees Celsius/minute to 11 degrees Celsius/minute.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An adhesive tape comprising a first adhesive layer comprising:
a. a pressure sensitive adhesive resin;
b. a first crosslinkable component; and
c. a second crosslinkable component,
wherein the first crosslinkable component has a greater weight percentage in the adhesive layer than the second crosslinkable component, based on the total dry weight of the adhesive layer,
wherein the first crosslinkable component is different than the second crosslinkable component, and
wherein the second crosslinkable component has a lower cure temperature than the first crosslinkable component.

2. The adhesive tape of claim 1, wherein the adhesive tape comprises the first adhesive layer, a core layer, and a second adhesive layer, wherein the core layer is disposed between the first adhesive layer and the second adhesive layer.

3. The adhesive tape of claim 2, wherein the first adhesive layer directly contacts the core layer on a first major surface, and wherein the second adhesive layer directly contacts the core layer on a second major surface, and wherein the first major surface is opposite the second major surface on the core layer.

4. The adhesive tape of claim 3, wherein the first and second adhesive layers each form opposing outer layers of the adhesive tape.

5. The adhesive tape of claim 2, wherein the core layer has a shear strength of at least 2 MPa.

6. The adhesive tape of claim 2, wherein the core layer has a T-block strength of at least 2 MPa.

7. The adhesive tape of claim 2, wherein the adhesive layer and/or the second adhesive layer at least partially impregnates the core layer.

8. The adhesive tape of claim 1, wherein the first crosslinkable component has at least one allyl group.

9. The adhesive tape of claim 1, wherein the first crosslinkable component comprises diallyl orthophthalate.

10. The adhesive tape of claim 1, wherein the first crosslinkable component is non-volatile and wherein the first crosslinkable component provides a reduction in viscosity to the acrylic resin.

11. The adhesive tape of claim 1, wherein the first crosslinkable component has a general formula 1 or 2:
CH2=CHCOOROOCCH═CH2 (1)
CH2=CHCH2OCOROCOCH2CH═CH2 (2)
wherein, R represents an aliphatic compound having from 1 to 12 carbon atoms, an ether group, an alicyclic hydrocarbon, or an aromatic hydrocarbon (having ortho-, iso-, or tere-structure).

12. The adhesive tape of claim 1, wherein the first crosslinkable component is present in the adhesive layer in an amount of at least about 3 wt. %.

13. The adhesive tape of claim 1, wherein the second crosslinkable component comprises a structural adhesive resin.

14. The adhesive tape of claim 1, wherein the adhesive layer further comprises a heat resistant resin.

15. The adhesive tape of claim 1, wherein the heat resistant resin comprises acrylate, polyurethane (PU), a diallyl orthophthalate prepolymer, or combinations thereof.

16. An adhesive tape comprising:
a. a first adhesive layer, wherein the first adhesive layer comprises an acrylic resin and a first crosslinkable component;
b. a core layer, wherein the second layer has a greater thickness than the adhesive layer, wherein the second layer forms a core of the article; and
c. a second adhesive layer, wherein the second adhesive layer comprises an acrylic resin and a first crosslinkable component.

17. The adhesive tape of claim 16, wherein the adhesive tape is adapted to adhere a component to a polymeric surface or a glass surface.

18. An adhesive tape comprising a first adhesive layer comprising:
a. a pressure sensitive adhesive resin; and
b. a first crosslinkable component;
wherein the adhesive tape has at least two of the following characteristics:
an overlap shear strength of greater than 8 MPa as measured according to the Lap Shear Test after aging of at least 4 months;
a pressure sensitive performance of not greater than 10⁶ G′(Pa) at a temperature of not greater than 20 degrees Celsius; and/or
a shelf life of at least 6 months as measured according to the Shelf Life modulus or experimental test.

19. The adhesive tape of claim 18, wherein the first adhesive layer further comprises a second crosslinkable component, wherein the first crosslinkable component is different than the second crosslinkable component, wherein the first crosslinkable component has a greater weight percentage in the adhesive layer than the second crosslinkable component, based on the total dry weight of the adhesive layer, and wherein the second crosslinkable component has a lower cure temperature than the first crosslinkable component.

20. The adhesive tape of claim 19, wherein the first crosslinkable component comprises diallyl orthophthalate and the second crosslinkable component comprises an epoxy, phenolic aldehyde, urea formaldehyde, alkyd resin, urethane, or combinations thereof.
